(19) United States
(12) Patent Application Publication
(10) Pub. No.: US 2016/0042656 A1
(43) Pub. Date: Feb. 11, 2016

(54) APPARATUS AND METHOD FOR CONTROLLING VIRTUAL TRAINING SIMULATION

(71) Applicant: ELECTRONICS AND TELECOMMUNICATIONS RESEARCH INSTIT UTE, Daejeon (KR)

(72) Inventors: Yang-Koo Lee, Cheongju-si (KR); Kyo-Il Chung, Daejeon (KR); So-Yeon Lee, Daejeon (KR); Sang-Joon Park, Daejeon (KR); Blagovest Iordanov Vladimirov, Changwon-si (KR); Young-Jae Lim, Daejeon (KR); Jong-Hyun Park, Daejeon (KR)

(21) Appl. No.: 14/817,403

(22) Filed: Aug. 4, 2015

(30) Foreign Application Priority Data
Aug. 7, 2014 (KR) 10-2014-0101530

(51) Int. Cl. G09B 9/00; G09B 5/00

(52) U.S. Cl. CPC G09B 9/00; G09B 5/00

(57) ABSTRACT

An apparatus and method for controlling virtual training simulation are disclosed herein. The apparatus for controlling virtual training simulation includes a posture recognition unit, a posture information convergence unit, a location recognition processing unit, and a movement device control unit. The posture recognition unit recognizes the posture of a trainee based on the image information of the inside of a virtual training field and motion sensor information. The posture information convergence unit generates converged information by converging the results of the recognition of the posture of the trainee. The location recognition processing unit estimates the current location of the trainee based on the converged information. The movement device control unit controls an omnidirectional movement device in which the trainee is placed using information about the control state of the omnidirectional movement device and the current location of the trainee.

### CROSS-REFERENCE TO RELATED APPLICATION

This application claims the benefit of Korean Patent Application No. 10-2014-0101530, filed Aug. 7, 2014, which is hereby incorporated by reference herein in its entirety.

### BACKGROUND

1. Technical Field

Embodiments of the present invention relate generally to an apparatus and method for controlling virtual training simulation and, more particularly, to an apparatus and method for controlling virtual training simulation that recognize the location of a trainee on an omnidirectional movement device in real time, control the omnidirectional movement device so that the trainee does not depart from the omnidirectional movement device based on the result of the recognition, and then control a virtual trainee avatar in response to the motion and behavior of the trainee.

2. Description of the Related Art

With the recent rapid growth of virtual reality technology, it has be widely applied to industrial fields, such as medical service, gaming, military affairs, and public fields. For example, virtual operation simulation systems for surgeons, rehabilitation training systems for patients, training systems for athletes, and methods for recognizing the hand motion or movement of a person and then controlling an avatar in a game are all based on virtual reality technology.

As an example, Korean Patent Application Publication No. 2013-0100517 entitled “Bobsled Simulator and Method for Controlling Process” discloses virtual reality technology for providing geographical or scenery information corresponding to a bobsled course to a trainee and also providing a more realistic experience by implementing changes, occurring upon the manipulation of a bobsled of the trainee, via a simulator module or a display.

In particular, in the case of the military field, the improvement of the effects of military drills is focused on by replacing or supplementing an actual training situation, such as aviation training or combat training, with a virtual training environment. The reason for this is that since the tendency of modern combat has changed from large-sized military operations to small-sized unit operations, such as counter terrorism, the crackdown on piracy at sea, hostage rescue and disaster relief, and requires technology for operating an expensive and advanced weapons system, the effort to reduce training expenses and overcome spatial restrictions is necessary.

In order to improve the efficiency of a virtual combat training system for military soldiers, the sensation of reality in a virtual space needs to be maximized, and high sense-based stability and athletic skill training similar to that of an actual battle experience need to be provided to trainees.

However, current technology is disadvantageous in that it is difficult to control a movement device in accordance with the walking face of each trainee because various changes in the walking of trainees and changes in irregular and fast motions cannot be supported in real time, with the result that the stable walking and motion of the trainee are impossible. Furthermore, although there are simulators for weapons systems, such as streetcars and combat planes, there is no training apparatus that enables a solider to feel sensations similar to those experienced in an actual combat situation.

### SUMMARY

At least some embodiments of the present invention are directed to the provision of an apparatus and method for controlling virtual training simulation that recognize the location of a trainee on an omnidirectional movement device in real time, control the omnidirectional movement device so that the trainee does not depart from the omnidirectional movement device based on the result of the recognition, and then control a virtual trainee avatar in response to the motion and behavior of the trainee.

In accordance with an aspect of the present invention, there is provided a method of controlling virtual training simulation, including: by an apparatus for controlling virtual training simulation in a virtual training field including an omnidirectional movement device in which a trainee is placed, receiving the image information of the inside of the virtual training field and motion sensor information; estimating the current location of the trainee based on the image information and the motion sensor information; and controlling the omnidirectional movement device using the estimated current location of the trainee so that the trainee is placed at the center of the omnidirectional movement device.

Estimating the current location of the trainee may include: recognizing a posture of the trainee based on the image information, and then predicting a subsequent posture of the trainee; recognizing a posture of the trainee based on the motion sensor information, and then predicting a subsequent posture of the trainee; generating converged information by converging the results of the recognition and the prediction; and estimating location recognition information including the current location of the trainee by analyzing information about an exercise and location of the trainee based on the converged information.

Receiving the image information and the motion sensor information, estimating the current location of the trainee, and controlling the omnidirectional movement device may be repeated until the virtual training simulation is terminated.

In accordance with another aspect of the present invention, there is provided a method of controlling virtual training simulation, including: by an apparatus for controlling a virtual training simulation in a virtual training field, receiving the image information of the inside of the virtual training field and motion sensor information; recognizing the behavior of a trainee within the virtual training field using the image information and the motion sensor information; and controlling a virtual trainee avatar so that the virtual trainee avatar moves in response to the recognized behavior of the trainee.

Recognizing the behavior of the trainee may include: recognizing a posture of the trainee based on the image information, and predicting a subsequent posture of the trainee; recognizing a posture of the trainee based on the motion sensor information, and predicting a subsequent posture of the trainee; generating converged information by converging the results of the recognition and the prediction; and extracting the behavior features of the trainee from the converged information, and recognizing the behavior of the trainee by analyzing the extracted behavior features.

The virtual training field may include an omnidirectional movement device in which the trainee is placed; and the method may further include controlling the omnidirectional movement device so that the trainee is placed at a center of the omnidirectional movement device.

Controlling the omnidirectional movement device may include estimating a current location of the trainee based on the converged information; and controlling the omnidirectional movement device using the estimated current location of the trainee so that the trainee is placed at the center of the omnidirectional movement device.

In accordance with still another aspect of the present invention, there is provided an apparatus for controlling virtual training simulation, including: a posture recognition unit configured to recognize the posture of a trainee based on the image information of the inside of a virtual training field and motion sensor information; a posture information convergence unit configured to generate converged information by converging the results of the recognition of the posture of the trainee; a location recognition processing unit configured to estimate the current location of the trainee based on the converged information; and a movement device control unit configured to control an omnidirectional movement device in which the trainee is placed using information about the control state of the omnidirectional movement device and the current location of the trainee so that the trainee is placed at the center of the omnidirectional movement device.

The information about the control state of the omnidirectional movement device may correspond to at least one of information about the rotation speed, rotation region and friction of the omnidirectional movement device.

The apparatus may further include: a behavior recognition unit configured to extract behavior features of the trainee from the converged information and recognize the behavior of the trainee by analyzing the extracted behavior features; and a virtual space control unit configured to control a virtual trainee avatar so that the virtual trainee avatar moves in response to the recognized behavior of the trainee.

The information about the image of the inside of the virtual training field and the motion sensor information may be received from an image camera placed within the virtual training field and a motion sensor worn by the trainee.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an environment for a virtual training field to which an apparatus for controlling virtual training simulation according to an embodiment of the present invention is applied;

FIG. 2 is a diagram schematically illustrating the configuration of an apparatus for controlling virtual training simulation according to an embodiment of the present invention;

FIG. 3 is a diagram schematically illustrating the configuration of a trainee control server according to an embodiment of the present invention;

FIG. 4 is a flowchart illustrating a method of controlling virtual training simulation and a method of controlling an omnidirectional movement device by using the method of controlling virtual training simulation according to embodiments of the present invention; and

FIG. 5 is a flowchart illustrating a method of controlling virtual training simulation and a method of controlling the avatar of a virtual training simulator in response to a motion and behavior of an actual trainee by using the method of controlling virtual training simulation according to embodiments of the present invention.

### DETAILED DESCRIPTION

Embodiments of the present invention will be described in detail below with reference to the accompanying drawings. Redundant descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

An apparatus and method for controlling virtual training simulation according to embodiments of the present invention are described in detail below with reference to the accompanying drawings.

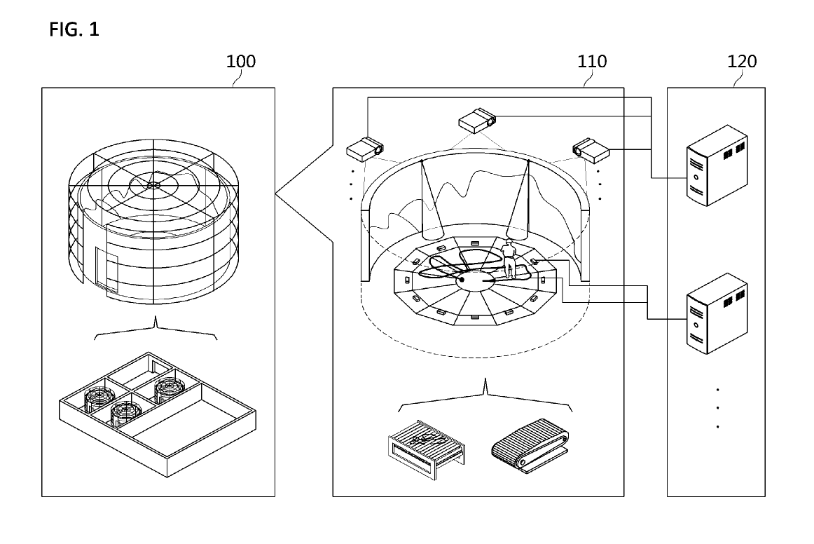

FIG. 1 is a diagram illustrating an environment for a virtual training field 100 to which an apparatus for controlling virtual training simulation according to an embodiment of the present invention is applied.

Referring to FIG. 1, the virtual training field 100 to which the apparatus for controlling virtual training simulation is applied is configured to have a cylindrical shape and have an inner wall surrounded by a 360-degree screen.

The virtual training field 100 may have a cylindrical shape or a dome shape.

An omnidirectional movement device configured to enable a trainee to always maintain his or her location at the center of a limited space, a plurality of image output devices configured to output a virtual combat training scenario, a depth and RGB image camera configured to track the posture and motion of the trainee in real time, a motion sensor worn by the trainee, and an image recording device configured to monitor the internal state of the virtual training field are deployed within the inside 110 of the virtual training field 100.

The apparatus for controlling virtual training simulation for controlling the omnidirectional movement device and a virtual space using data obtained from the inside 110 of the virtual training field 100 is placed in the outside 120 of the virtual training field 100.

Although the omnidirectional movement device according to the present embodiment has been illustrated as being surrounded by the 360-degree screen, the screen is not limited to a specific shape. Images displayed on the 360-degree screen may be projected from the upper portion of the virtual training field via the plurality of image output devices placed within the inside 110 of the virtual training field 100, or the screen itself may function as a monitor.

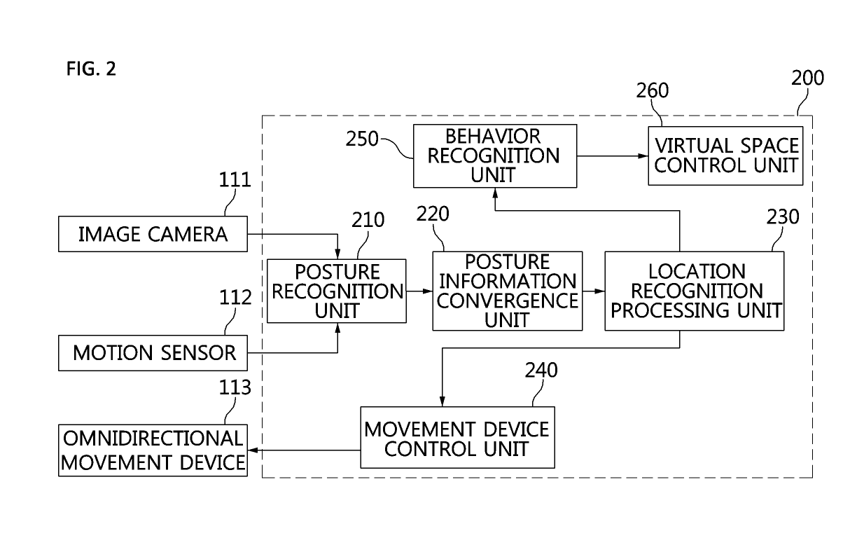

An apparatus for controlling virtual training simulation according to an embodiment of the present invention is described in detail below with reference to FIG. 2.

FIG. 2 is a diagram schematically illustrating the configuration of the apparatus for controlling virtual training simulation according to the present embodiment.

Referring to FIG. 2, the apparatus 200 for controlling virtual training simulation includes a posture recognition unit 210, a posture information convergence unit 220, a location recognition processing unit 230, a movement device control unit 240, a behavior recognition unit 250, and a virtual space control unit 260.

The posture recognition unit 210 receives information about a motion of a trainee received from an image camera 111 and a motion sensor 112, for example, depth and RGB image information and motion sensor information, extracts features from the received information, and recognizes the posture of the trainee based on the extracted features. In this case, the image camera 111 corresponds to a depth and RGB image camera, but is not limited thereto.

The posture information convergence unit 220 generates converged information by converging the depth and RGB image information, the motion sensor information, and information about the recognized posture of the trainee.

The location recognition processing unit 230 analyzes information about the exercise and location of the trainee based on the converged information, and estimates location recognition information, including the moving distance, direction and speed of the trainee.

The movement device control unit 240 obtains information about the control state of the omnidirectional movement device 113 that corresponds to information about the rotation speed, rotation region, and friction of the omnidirectional movement device 113, and controls the omnidirectional movement device 113 using the information about the control state of the obtained omnidirectional movement device 113 and the location recognition information estimated by the location recognition processing unit 230 so that the trainee is placed at the center of the omnidirectional movement device 113.

The behavior recognition unit 250 extracts the behavior features of the trainee from the depth and RGB image information, the motion sensor information, the information about the recognized posture of the trainee information, and the location recognition information, and recognizes the behavior of the trainee by analyzing the extracted behavior features.

The virtual space control unit 260 controls a virtual trainee avatar so that the behavior of the trainee recognized by the behavior recognition unit 250 coincides with that of the virtual trainee avatar.

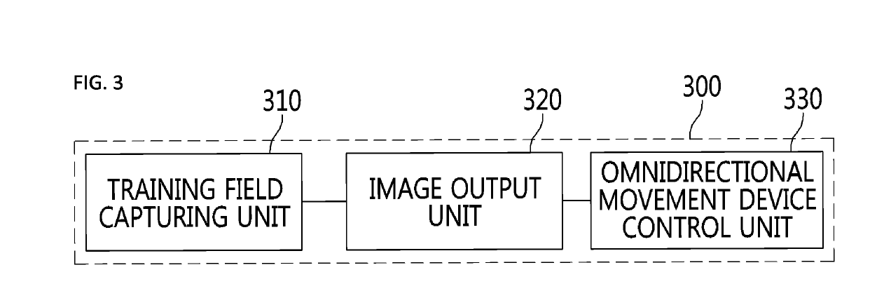

A trainee control server for monitoring the training state and danger situation of a trainee within the virtual training field 100 and controlling the internal environment of the training field when an exception situation occurs is described in detail below with reference to FIG. 3.

FIG. 3 is a diagram schematically illustrating the configuration of a trainee control server 300 according to an embodiment of the present invention.

Referring to FIG. 3, the trainee control server 300 includes a training field capturing unit 310, an image output unit 320, and an omnidirectional movement device control unit 330.

The training field capturing unit 310 includes an image camera for capturing the inside of the training field.

The image output unit 320 receives an image captured by the training field capturing unit 310 in the outside the training field, and outputs the captured image.

The omnidirectional movement device control unit 330 controls the omnidirectional movement device that may function as a dangerous factor that needs to be immediately controlled when an exception situation among the output results of the image output unit 320 occurs during training.

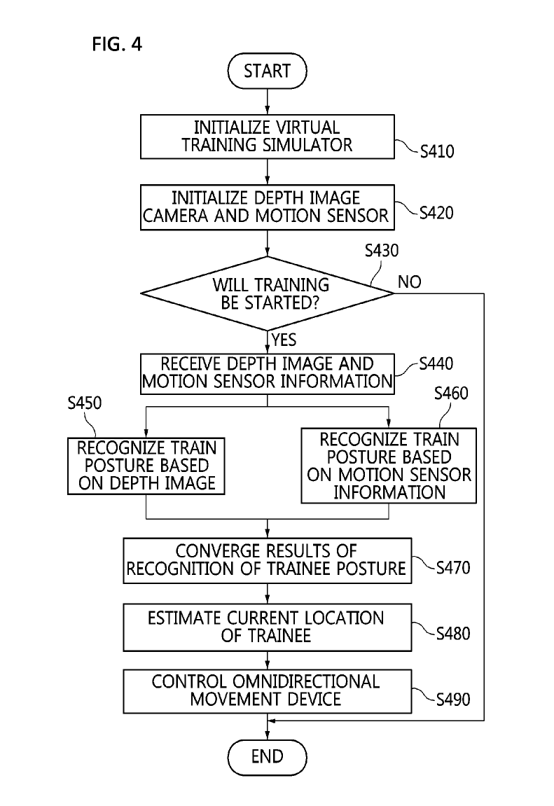

A method of controlling virtual training simulation and a method of controlling the omnidirectional movement device by using the method of controlling virtual training simulation are described in detail below with reference to FIG. 4.

FIG. 4 is a flowchart illustrating the method of controlling virtual training simulation and the method of controlling an omnidirectional movement device by using the method of controlling virtual training simulation according to embodiments of the present invention.

Referring to FIG. 4, when virtual training is started in the virtual training field 100, the apparatus 200 for controlling virtual training simulation initializes a virtual training simulator at step S410.

The apparatus 200 for controlling virtual training simulation is initialized, and initializes the depth and RGB image camera 111 configured to track the posture and motion of a trainee in real time and the motion sensor 112 worn by the trainee to the original posture of the trainee at step S420.

The apparatus 200 for controlling virtual training simulation checks whether virtual training will be started in the virtual training field 100 at step S430.

If, as a result of the checking at step S430, it is found that the virtual training will be started, the apparatus 200 for controlling virtual training simulation receives depth and RGB image information and motion sensor information generated according to the scenario of the virtual training simulator at step S440. In this case, the depth and RGB image information and the motion sensor information are received from the image camera 111 and the motion sensor 112 placed within the inside 110 of the virtual training field 100.

At step S450, the apparatus 200 for controlling virtual training simulation recognizes the posture of the trainee and predicts a subsequent posture of the trainee based on the depth and RGB image information received at step S440.

At step S460, the apparatus 200 for controlling virtual training simulation recognizes the posture of the trainee and predicts a subsequent posture of the trainee based on the motion sensor information received at step S440.

At step S470, the apparatus 200 for controlling virtual training simulation generates converged information by converging the results of the recognition and the prediction obtained at steps S450 and S460.

At step S480, the apparatus 200 for controlling virtual training simulation estimates location recognition information, including the moving distance, moving direction, and moving speed of the trainee, by analyzing the result of the convergence obtained at step S470, that is, information about the exercise and location of the trainee, from the converged information. More specifically, the apparatus 200 for controlling virtual training simulation relatively estimates the current location of the trainee to a previous location by analyzing the result converged at step S470, that is, the converged information.

At step S490, the apparatus 200 for controlling virtual training simulation controls the omnidirectional movement device 113 by the distance and direction over and in which the trainee has moved using information about the control state of the omnidirectional movement device 113 and the location recognition information of the trainee estimated so that the trainee is placed at the center of the omnidirectional movement device 113 at step S480.

The apparatus 200 for controlling virtual training simulation according to the present embodiment repeats steps S440 to S490 until the virtual training found to be started at step S430 is terminated, but is not limited thereto.

As described above, in accordance with at least some embodiments of the present invention, the degree of sense-based stability of a trainee who is trained on the omnidirectional movement device can be maximized by recognizing the location of the trainee on the omnidirectional movement device in real time and then controlling the omnidirectional movement device based on the result of the recognition so that the trainee does not depart from the omnidirectional movement device.

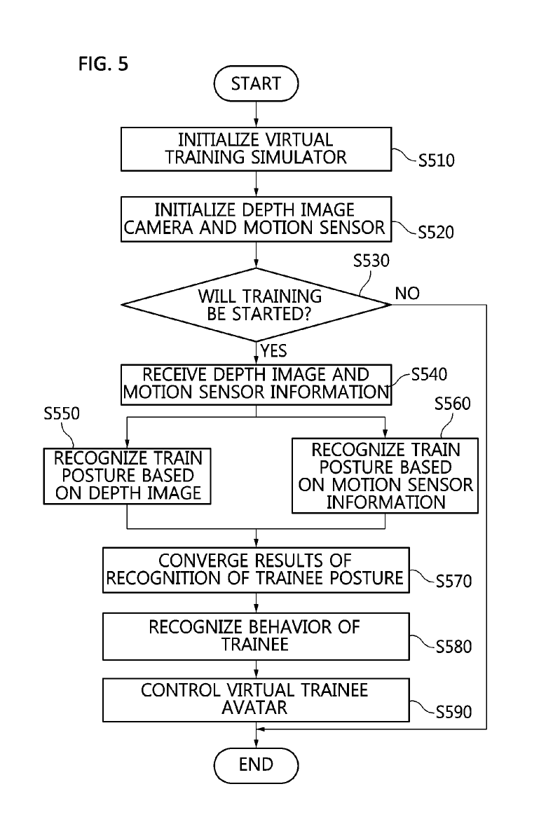

A method of controlling virtual training simulation and a method of controlling the avatar of the virtual training simulator in response to a motion and behavior of an actual trainee are described in detail below with reference to FIG. 5.

FIG. 5 is a flowchart illustrating the method of controlling virtual training simulation and the method of controlling the avatar of a virtual training simulator in response to a motion and behavior of an actual trainee by using the method of controlling virtual training simulation according to embodiments of the present invention.

Referring to FIG. 5, when virtual training is started in the virtual training field 100, the apparatus 200 for controlling virtual training simulation initializes a virtual training simulator at step S510.

The apparatus 200 for controlling virtual training simulation is initialized, and initializes the depth and RGB image camera 111 configured to track the posture and motion of a trainee in real time and the motion sensor 112 worn by the trainee to the original posture of the trainee at step S520.

The apparatus 200 for controlling virtual training simulation checks whether virtual training will be started in the virtual training field 100 at step S530.

If, as a result of the checking at step S530, it is found that the virtual training will be started, the apparatus 200 for controlling virtual training simulation receives depth and RGB image information and motion sensor information generated according to the scenario of the virtual training simulator at step S540. In this case, the depth and RGB image information and the motion sensor information are received from the image camera 111 and the motion sensor 112 placed within the inside 110 of the virtual training field 100.

At step S550, the apparatus 200 for controlling virtual training simulation recognizes the posture of the trainee and predicts a subsequent posture of the trainee based on the depth and RGB image information received at step S540.

At step S560, the apparatus 200 for controlling virtual training simulation recognizes the posture of the trainee and predicts a subsequent posture of the trainee based on the motion sensor information received at step S540.

At step S570, the apparatus 200 for controlling virtual training simulation generates converged information by converging the results of the recognition and the prediction obtained at steps S550 and S560.

At step S580, the apparatus 200 for controlling virtual training simulation extracts the behavior features of the trainee from the result of the convergence obtained at step S570, that is, converged information, and recognizes the behavior of the trainee by analyzing the extracted behavior features.

At step S590, the apparatus 200 for controlling virtual training simulation controls a virtual trainee avatar so that the virtual trainee avatar moves in response to the behavior of the trainee recognized at step S580.

The apparatus 200 for controlling virtual training simulation according to the present embodiment may repeat steps S540 to S590 until the virtual training found to be started at step S530 is terminated, but is not limited thereto.

In accordance with at least some embodiments of the present invention, a virtual battlefield environment similar to an expected combat area can be constructed and also soldiers can be trained in the virtual battlefield environment in order so that a mission can be completed without loss of life when an actual operation is performed. Accordingly, the probability that an operation is successful can be improved, and an environment in which a trainee can be trained by simulating actual reality without sensations of uneasiness or dizziness can be provided.

Furthermore, the apparatus and method for controlling virtual training simulation according to at least some embodiments of the present invention can be efficiently provided for combat training based on a squad or platoon, such as special warfare, a counterterrorist operation, a street battle, and disaster relief.

Moreover, in accordance with at least some embodiments of the present invention, the degree of sense-based stability of a trainee who is trained on the omnidirectional movement device can be maximized by recognizing information about the posture, motion, moving distance, speed and direction of the trainee in real time and then controlling the omnidirectional movement device based on the results of the recognition, that is, in accordance with the movement pattern of the trainee.

As described above, the optimum embodiments have been disclosed in the drawings and the specification. Although the specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. A method of controlling virtual training simulation, comprising:
by an apparatus for controlling virtual training simulation in a virtual training field comprising an omnidirectional movement device in which a trainee is placed,
receiving image information of an inside of the virtual training field and motion sensor information;
estimating a current location of the trainee based on the image information and the motion sensor information; and
controlling the omnidirectional movement device using the estimated current location of the trainee so that the trainee is placed at a center of the omnidirectional movement device.

2. The method of claim 1, wherein estimating the current location of the trainee comprises:
recognizing a posture of the trainee based on the image information, and then predicting a subsequent posture of the trainee;
recognizing a posture of the trainee based on the motion sensor information, and then predicting a subsequent posture of the trainee;
generating converged information by converging the results of the recognition and the prediction; and
estimating location recognition information including the current location of the trainee by analyzing information about an exercise and location of the trainee based on the converged information.

3. The method of claim 1, wherein receiving the image information and the motion sensor information, estimating the current location of the trainee, and controlling the omnidirectional movement device are repeated until the virtual training simulation is terminated.

4. A method of controlling virtual training simulation, comprising:
by an apparatus for controlling a virtual training simulation in a virtual training field,
receiving image information of an inside of the virtual training field and motion sensor information;
recognizing behavior of a trainee within the virtual training field using the image information and the motion sensor information; and
controlling a virtual trainee avatar so that the virtual trainee avatar moves in response to the recognized behavior of the trainee.

5. The method of claim 4, wherein recognizing the behavior of the trainee comprises:
recognizing a posture of the trainee based on the image information, and predicting a subsequent posture of the trainee;
recognizing a posture of the trainee based on the motion sensor information, and predicting a subsequent posture of the trainee;
generating converged information by converging results of the recognition and the prediction; and
extracting behavior features of the trainee from the converged information, and recognizing the behavior of the trainee by analyzing the extracted behavior features.

6. The method of claim 4, wherein:
the virtual training field comprises an omnidirectional movement device in which the trainee is placed; and
the method further comprises controlling the omnidirectional movement device so that the trainee is placed at a center of the omnidirectional movement device.

7. The method of claim 6, wherein controlling the omnidirectional movement device comprises:
estimating a current location of the trainee based on the converged information; and
controlling the omnidirectional movement device using the estimated current location of the trainee so that the trainee is placed at the center of the omnidirectional movement device.

8. An apparatus for controlling virtual training simulation, comprising:
a posture recognition unit configured to recognize a posture of a trainee based on image information of an inside of a virtual training field and motion sensor information;
a posture information convergence unit configured to generate converged information by converging results of the recognition of the posture of the trainee;
a location recognition processing unit configured to estimate a current location of the trainee based on the converged information; and
a movement device control unit configured to control an omnidirectional movement device in which the trainee is placed using information about a control state of the omnidirectional movement device and the current location of the trainee so that the trainee is placed at a center of the omnidirectional movement device.

9. The apparatus of claim 8, wherein the information about the control state of the omnidirectional movement device corresponds to at least one of information about a rotation speed, rotation region, and friction of the omnidirectional movement device.

10. The apparatus of claim 8, further comprising:
a behavior recognition unit configured to extract behavior features of the trainee from the converged information and recognize behavior of the trainee by analyzing the extracted behavior features; and
a virtual space control unit configured to control a virtual trainee avatar so that the virtual trainee avatar moves in response to the recognized behavior of the trainee.

11. The apparatus of claim 8, wherein the information about the image of the inside of the virtual training field and the motion sensor information are received from an image camera placed within the virtual training field and a motion sensor worn by the trainee.
